(19) United States
(12) Patent Application Publication
(10) Pub. No.: US 2026/0326216 A1
(43) Pub. Date: Oct. 22, 2026

(54) REMOVABLE WORKING MEMBER FOR A DEMOLITION CLAMP

(71) Applicant: INDECO IND S.p.A., Bari (IT)

(72) Inventors: Alessandro CICCOLELLA, Bari (IT); Mauro VITULANO, Bari (IT)

(73) Assignee: INDECO IND S.p.A., Bari (IT)

(21) Appl. No.: 19/567,390

(22) Filed: Mar. 16, 2026

(30) Foreign Application Priority Data
Mar. 18, 2025 (IT) 102025000005496

(51) Int. Cl. B23D 17/00; B23D 35/00

(52) U.S. Cl. CPC B23D 17/00; B23D 35/008

(57) ABSTRACT

A removable working member for a demolition clamp includes a body with a working portion, which is configured to come into contact with the material to be demolished. The removable working member also includes a base with a shaped base portion that is configured to removably engage by form-fit coupling with a counter-shaped base portion of a receiving seat formed in a corresponding jaw.

### TECHNICAL FIELD

The present invention relates to a removable working member for a demolition clamp. The present invention also relates to a demolition clamp.

### BACKGROUND

Demolition clamps are well-known and widely used tools for demolishing structures and artifacts made of concrete, steel, or mixed materials. These hydraulic devices are designed to be mounted on earthmoving machinery, especially excavators.

Their main structure consists of a metal frame, typically high-strength steel, designed to withstand heavy loads and ensure operational reliability. This frame houses both the mechanical and hydraulic components and supports the jaw system, which can be configured with two movable jaws or one fixed and one movable jaw, depending on the application. The jaws are equipped with interchangeable teeth or cutting blades, depending on the type of demolition being performed. The movement of the jaws is generated by a hydraulic system composed of one or more cylinders, which transform the excavator's hydraulic energy into mechanical force applied directly to the jaws to crush the material.

There are known solutions with teeth that are removable/interchangeable on the jaws of demolition clamps. Specifically, in these well-known solutions, the teeth are secured by locking pins and housed in connection seats that require translational assembly. This configuration requires the tooth to be inserted in a predetermined direction, typically through a linear movement, until it is fully housed in the seat, where it is then mechanically locked using threaded pins or additional fastening systems.

While this solution ensures a certain stability of the connection, it presents several practical and functional disadvantages. Translational assembly requires precise alignment between the tooth and its seat, making replacement operations more complex and increasing maintenance time. Furthermore, these solutions envisage the use of pins which are threaded and/or provided with anti-rotation systems, which, over time, can wear or loosen, compromising the reliability of the connection and requiring frequent maintenance.

A further limitation of these systems is their adaptability to different categories of operating machinery. For large machines, these solutions are unreliable, which is why welded teeth or teeth made in a single piece with a movable jaw are often used, thus eliminating the possibility of replacement. This leads to longer machine downtime and high maintenance costs, as tooth wear requires more complex interventions and sometimes the replacement of the entire jaw. In particularly demanding applications, such as the demolition of reinforced concrete or steel structures, these limitations become even more evident, as high stresses can accelerate the deterioration of the connections and significantly reduce the system's operating life.

A further disadvantage of currently available solutions is the limited interchangeability of the tooth once worn. The replacement process is complex and cumbersome, precisely because of the need to remove and reinstall pins and screws. Furthermore, existing solutions do not ensure optimal distribution of crushing forces, as they are not effectively discharged onto the tooth seat. This can lead to uneven wear and a shorter tooth life.

Known solutions are described for example in US2011/297773 and DE69514905.

### OBJECTS OF THE INVENTION

An object of the present invention is to propose a demolition clamp that overcomes at least in part the drawbacks of known solutions.

Another object of the invention is to propose a demolition clamp which is simple, convenient and quick to maintain.

Another purpose of the invention is to facilitate and speed up the replacement of worn teeth in a demolition clamp.

Another object of the invention is to facilitate and speed up the assembly of an interchangeable tooth on a demolition clamp, while ensuring stable and reliable locking of the tooth to the respective jaw.

Another object of the invention is to reduce the operating costs of the demolition clamp.

Another object of the invention is to propose a demolition clamp which are constructionally completely reliable.

Another object of the invention is to propose a demolition clamp which is resistant and robust.

Another object of the invention is to propose a demolition clamp which is an improvement and/or alternative to traditional solutions.

Another object of the invention is to propose a demolition clamp which can be manufactured simply, quickly and at low cost.

Another object of the invention is to propose a demolition clamp with an alternative characterization, both in functional and implementation terms, compared to traditional ones.

Another object of the invention is to propose a valid solution for demolition clamps of various sizes.

Another object of the invention is to propose a removable working member for a demolition clamp which is simple and quick to replace and assemble, while ensuring high construction reliability and stable locking during operation.

Another object of the invention is to propose a removable working member for a demolition clamp that is simple, quick and economical to produce.

### SUMMARY

All the objects mentioned herein—considered both individually and in any combination thereof—and others which will result from the following description are achieved, according to the invention, with a removable working member according to the appended claims.

### BRIEF DESCRIPTION OF THE FIGURES

Further features and advantages of the present invention will be more evident from the description of some preferred, but not exclusive, practical embodiments of the solution according to the invention, illustrated, for purely exemplifying and indicative and non-limiting purposes, in the attached drawings wherein:

FIG. 1 shows a perspective view of the demolition clamp according to the invention,

FIG. 2 shows a perspective view of the clamp of FIG. 1 wherein the detail of the fixing of a tooth to the respective jaw has been exploded,

FIG. 3 shows the same view of FIG. 2 in a different perspective,

FIG. 4 shows the same view of FIG. 2 in a further different perspective,

FIG. 5 shows a side view of a detail of the demolition clamp according to the invention wherein the tooth is mounted on the respective jaw,

FIG. 6 shows the detail of FIG. 5 in an exploded perspective view,

FIG. 7 shows the detail of FIG. 5 in a different exploded perspective view,

FIGS. 8A-8D show, in lateral view, a detail of the tooth removal sequence from the respective jaw of the demolition clamp according to the invention,

FIGS. 9A-9D show, in lateral view, a detail of the tooth assembly sequence in the respective jaw of the demolition clamp according to the invention,

FIG. 10 shows in the same view of FIG. 5 a variant of the demolition clamp according to the invention,

FIG. 11 shows a side view of a detail of the variant of FIG. 10 wherein a (first) piece of the tooth is mounted while the other (second) piece is being removed (or mounted),

FIG. 12 shows a side view of a detail of the variant of FIG. 11 wherein a (first) piece of the tooth is being removed (or mounted), while the other piece is removed,

FIG. 13 shows in the same view of FIG. 5 a further variant of the demolition clamp according to the invention,

FIG. 14 shows in the same view the clamp of FIG. 13 with the working member positioned on the jaw at the insertion edge thereof,

FIG. 15 shows in a perspective view the whole demolition clamp in the same variant of FIG. 13 with an exploded working member which is provided with a plurality of cutting inserts, of which one is also in exploded view, and with the other working member mounted but without any cutting insert, and

FIG. 16 shows the clamp of FIG. 15 in a lateral view and with both working members mounted.

### DETAILED DESCRIPTION OF THE PREFERRED EMBODIMENTS

As can be seen from the figures, the demolition clamp 1 according to the invention comprises:
a frame 2 which is provided with a connection attachment 3 which is configured to connect the demolition clamp 1 to an earthmoving machine, for example to the end of an excavator arm,
two jaws 4′, 4″, of which at least one is movable and is articulated to the frame 2,
at least one linear actuator 5′, 5″ for each movable jaw, and wherein said at least one linear actuator has one end articulated to the frame 2 while the opposite end is articulated to the corresponding movable jaw 4′, 4″,
two working members 6′ and 6″, one for each jaw 4′, 4″, and of which at least one of said working members is removable, i.e. is configured to be removably mounted on the corresponding jaw.

Conveniently, the movable jaw(s) 4′, 4″ are moved by the respective actuators 5′, 5″ so as to move the working members 6′, 6″ mounted on the respective jaws closer to and further apart from each other to grip and crush the materials to be demolished. In particular, the jaw(s) 4′, 4″ of the demolition clamp 1 are movable between an open condition, wherein the working parts 6′, 6″ mounted on the respective jaws are spaced apart, and a closed condition, wherein the working parts 6′, 6″ mounted on the respective jaws are moved closer to each other.

Conveniently, the frame 2 serves as a structural support and connection for the other components.

Preferably, each linear actuator comprises a fluid-dynamic cylinder, more preferably a hydraulic cylinder.

Preferably, in a possible embodiment illustrated in the figures, the demolition clamp 1 comprises:
two movable jaws 4′, 4″ which are articulated to the frame 2,
two linear actuators 5′, 5″, one for each movable jaw, and wherein each linear actuator 5′, 5″ has one end articulated to the frame 2 while the opposite end is articulated to a corresponding movable jaw 4′, 4″,
two 6′, 6″ working members, both removable, each of which is removably mounted on a corresponding jaw.

Preferably, in a possible embodiment, the demolition clamp 1 according to the invention can also comprise a single movable jaw, while the other jaw is fixed.

Preferably, in one possible embodiment, one working member can be removable, while the other can be fixed in a non-removable manner to the respective jaw.

At least one or (preferably) both working members 6′, 6″ of the demolition clamp 1 are interchangeable, so that they can be replaced in the event of wear.

In at least one jaw 4′ and/or 4″ of the demolition clamp 1, a receiving seat 40 is obtained which is configured to receive said removable working member.

Conveniently, each removable working member 6′, 6″ comprises a body 60—preferably consisting of said body 60—which extends longitudinally (and mostly) along a direction parallel to X1, and also extends along directions parallel to Y1 and Z1, where the three directions X1, Y1 and Z1 are perpendicular to each other.

In particular, the body 60 extends:
in length along the X1 direction, corresponding to the direction of most elongated extension of said body,
in height along the direction parallel to Y1,
in thickness along the direction parallel to Z1.

Preferably, in a possible embodiment, said body 60 is made in a single piece, i.e. it is a monolithic body.

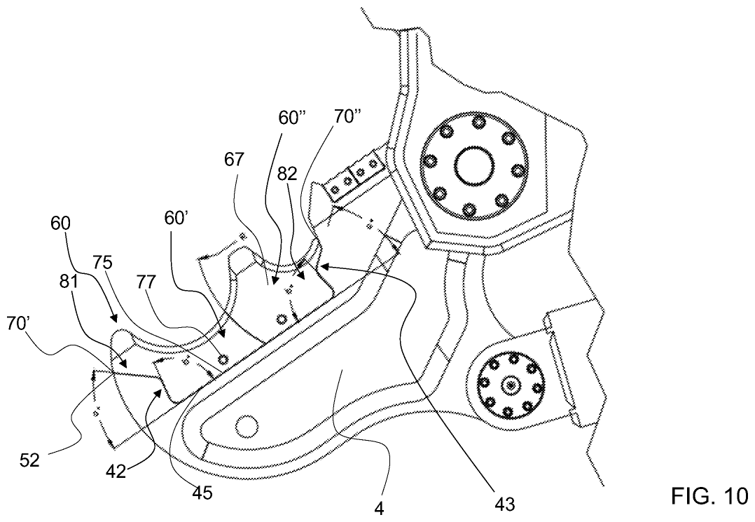

Preferably, in a possible alternative embodiment (see FIG. 10-12), the body 60 is made in several pieces and, in particular, in a first piece 60′ and in a second piece 60″.

The body 60 comprises two longitudinal ends, respectively a first longitudinal end 61 and a second longitudinal end 62, which are located on opposite sides along a direction parallel to X1.

The body 60 includes:
a working portion 63 that is configured to contact the material to be demolished,
a base 64 with a shaped base portion 80 that is configured to removably engage in form-fit coupling with a counter-shaped base portion 41 of the receiving seat 40 formed in the corresponding jaw 4′, 4″.

Conveniently, the form-fit coupling engagement of the shaped base portion 80 of the base 64 of the body 60 with the counter-shaped base portion 41 of the receiving seat 40 is configured to prevent, or in any case limit, movement of the body 60 with respect to the receiving seat (at least) along a direction parallel to Z1, and in both senses.

The body 60 comprises an end edge 70′ which defines a longitudinal end of the body 60. The end edge 70′ extends in a substantially continuous manner for the entire thickness of the body 60. In other words, the end edge 70′ extends with a substantially uniform trend, without discontinuities, variations in profile or changes in shape, thus defining a continuous and linear edge for the entire thickness of the body 60. Preferably, the end edge 70′ extends in a substantially continuous manner along a substantially rectilinear direction for the entire thickness of the body 60. Preferably, the end edge 70′ extends along a rectilinear direction which is substantially parallel to the direction Z1.

In a possible and preferred embodiment, the body 60 comprises two opposite end edges, each of which defines a respective longitudinal end of the body 60, and wherein said two opposite end edges extend along a substantially rectilinear direction for the entire thickness of the body 60.

Preferably, the end edge 70′ defines an insertion edge 70 to allow a rotary insertion, with the fulcrum at said insertion edge 70, of the body 60 into the receiving seat 40.

Preferably, the end edge 70′ is configured to constitute a first contact element (thus defining an insertion edge 70) during the assembly of the body 60 on the corresponding jaw 4′, 4″, guiding the rotary insertion of the body 60 with respect to the jaw itself.

Preferably, in a possible embodiment, the body 60 comprises, at the first longitudinal end 61 and/or the second longitudinal end 62, an insertion edge 70 to allow a rotary insertion, with a fulcrum at said insertion edge 70, of the body 60 into the receiving seat 40. More preferably, the body 60 is configured to be mounted on the corresponding jaw 4′, 4″ exclusively by means of a rotary insertion defined by the insertion edge 70, or by the insertion edges 70.

Preferably, during the assembly of the member 6′, 6″ on the corresponding jaw 4′, 4″, the insertion edge 70 constitutes the first contact point between the member 6′, 6″ and the jaw 4′, 4″.

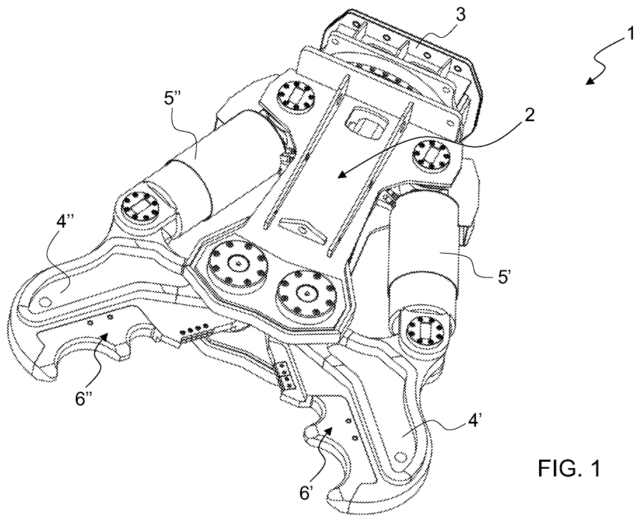

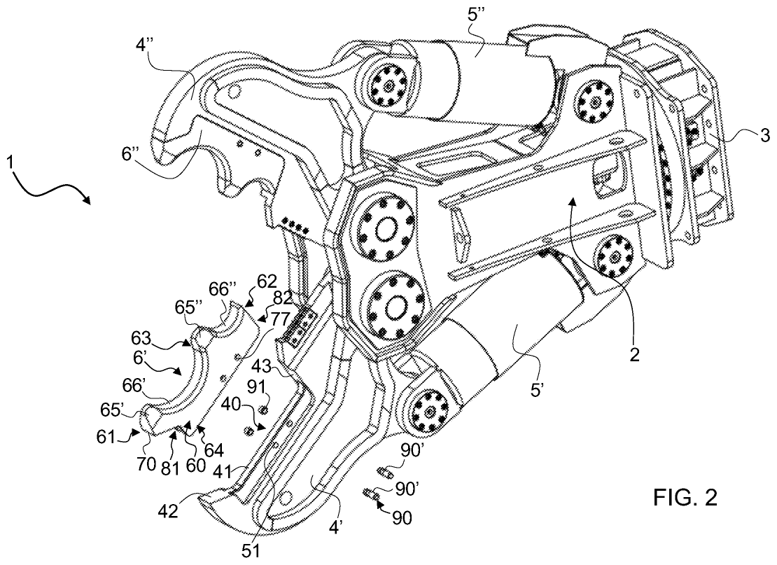

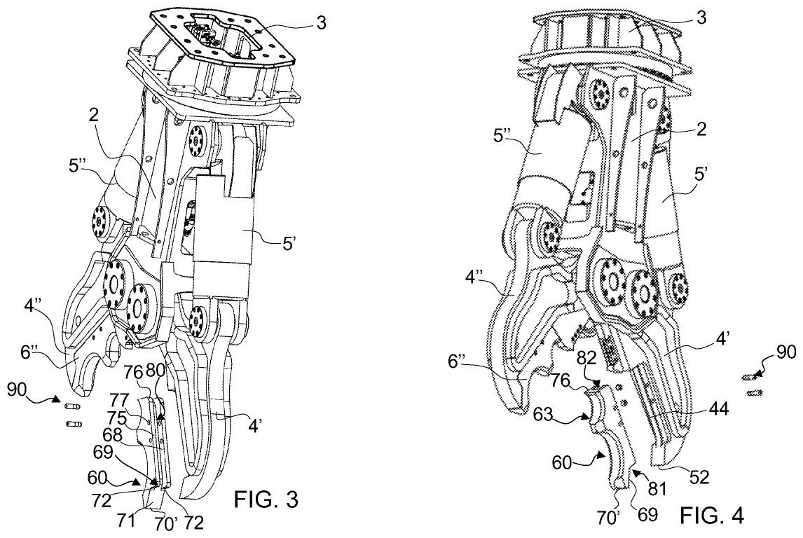

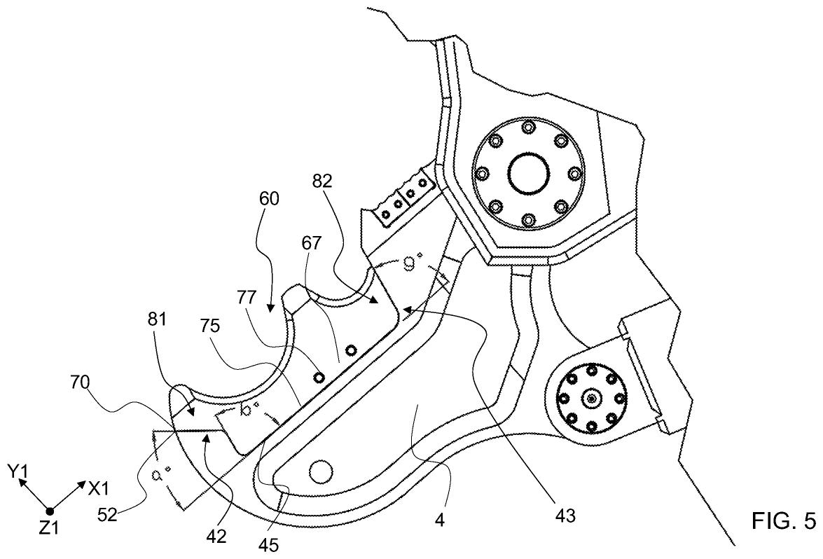

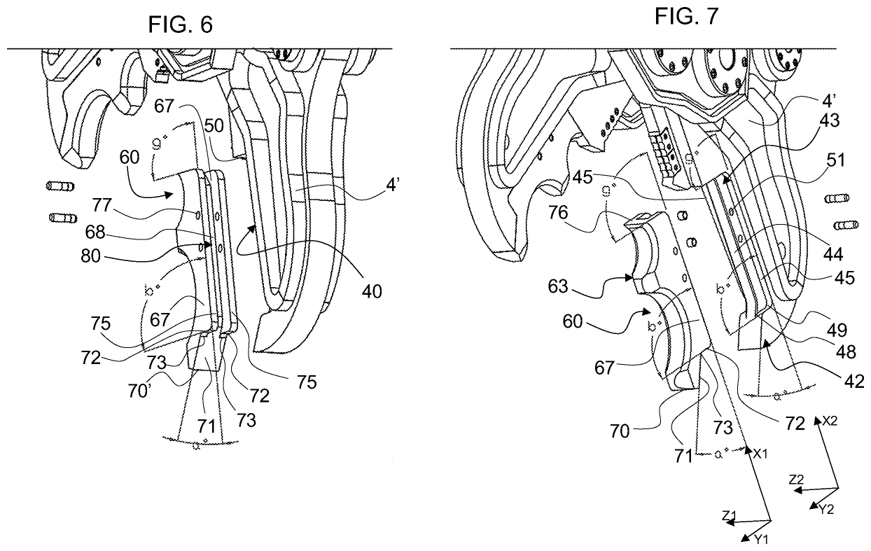

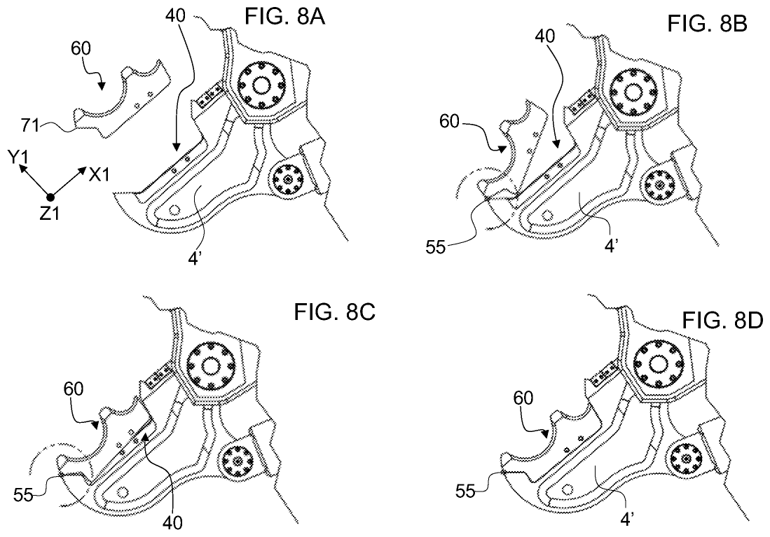

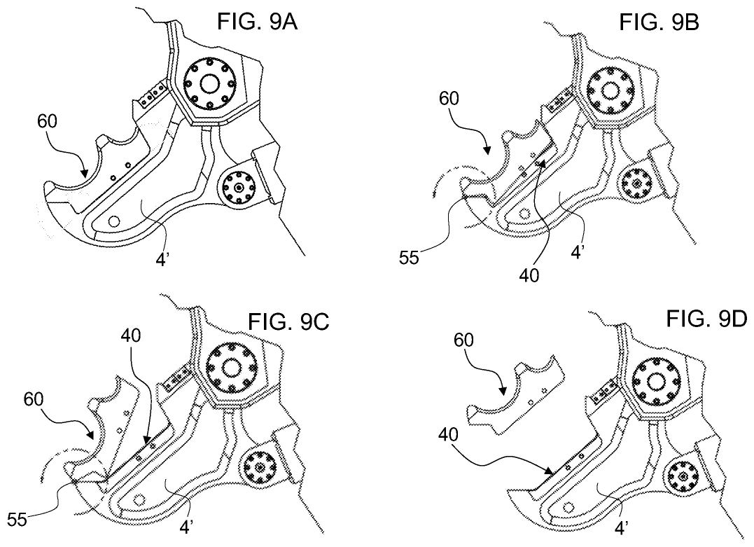

Preferably, in a possible embodiment illustrated in FIGS. 1-9D, at the first longitudinal end 61 there is an insertion edge 70 to allow a rotary insertion, with the fulcrum at said insertion edge 70, of the body 60 in the receiving seat 40.

Preferably, the insertion edge 70 is a sharp edge.

Conveniently, the insertion edge 70 is defined and extends within the thickness development (corresponding to the extension along a direction parallel to Z1) of the body 60.

Conveniently, the shaped base portion 80 can be configured to removably engage by form-fit coupling with the counter-shaped base portion 41 of the receiving seat 40 obtained in the corresponding jaw 4′, 4″ except for a limited mating play.

Conveniently, the shaped base portion 80 of the body 60 of each removable working member and the counter-shaped base portion 41 of the receiving seat 40 of the corresponding jaw 4′ or 4″ are configured so that, when the base 64 is fully inserted in the receiving seat 40, the movement of the body 60 is substantially blocked, or in any case limited, in (at least) two directions and, in particular, (at least) along the length direction (parallel to X1) and the thickness direction (parallel to Z1).

Preferably, the shaped base portion 80 of the body 60 of each removable working member and the counter-shaped base portion 41 of the receiving seat 40 of the corresponding jaw 4′ or 4″ are configured so that the movement of the body 60 is substantially blocked in all three directions X1, Y1 and Z1, remaining mobile in rotation around an axis parallel to Z1 and, in particular, around the insertion edge 70.

Preferably, in a possible embodiment, the shaped base portion 80 can be configured to removably engage by interlocking with the counter-shaped base portion 41 of the receiving seat 40 obtained in the corresponding jaw 4′, 4″.

Conveniently, the working portion 63 and the base 64 are substantially opposite along the height direction of the body 60, and in particular the working portion 63 is defined above in the body 60 while the base 64 is defined below in the body 60 (or vice versa).

Preferably, the working portion 63 may have various conformations to optimize the grip, penetration, crushing and/or cutting of the material to be demolished.

Preferably, the working portion 63 is toothed. Preferably, the working portion 63 comprises two or more teeth 65′ and/or 65″ protruding in the height direction. Preferably, the working portion 63 may comprise two or more teeth 65′ and/or 65″ or in any case raised/protruding and shaped sections, which may be spaced from each other by corresponding curved sections 66′ and/or 66″ with concavities facing outward.

In a possible and preferred embodiment, the working portion 63 may comprise two or more teeth and two or more curved sections with concavity facing outwards.

In particular, in a possible and preferred embodiment, the working portion 63 comprises:
a first tooth 65′ is obtained at a first end along the length direction, while a second tooth 65″ is obtained in a more internal position along the length direction,
a first curved section 66′ is placed between the first tooth 65′ and the second tooth 65″, while a second curved section 66″ ends at the other end along the length direction.

Preferably, the teeth and curved sections have a tapered shape with respect to the Y1-Z1 plane, with a variable angle, to maximize penetration into the material to be demolished.

The body 60 comprises two sides 67. In particular, the two sides 67 extend longitudinally and are opposed with respect to a plane defined by the direction of length and height.

In particular, the base 64 of the body 60 comprises a bottom surface 75. More specifically, the bottom surface 75 constitutes the lowest surface of the body 60 along its height (i.e., along a direction parallel to Y1). Preferably, the bottom surface 75 is substantially flat, and more preferably lies on a plane parallel to the directions X1 and Z1.

Preferably, the shaped base portion 80 comprises at least one depressed section that recedes inward from the body 60 relative to the bottom surface 75.

More preferably, the shaped base portion 80 of the body 60 may comprise a longitudinal central groove 68 which is interposed between two lateral sides 67 and which is configured to receive a longitudinal central rib 44 obtained in the receiving seat 40, or vice versa.

More preferably, the shaped base portion 80 comprises a longitudinal central groove 68, which is interposed between the two lateral sides 67 and, in particular, the bottom surface 75 is defined by the bottom sections of the lateral sides 67. Essentially, the sides 67 protrude along the height direction with respect to the depressed central section. Advantageously, the two lateral sides 67 delimit the longitudinal central groove 68 between them to thus extend the resistant section and balance the reactions.

The body 60 comprises, at the first longitudinal end 61, a first shaped portion 81 which is configured to removably engage in a form-fit coupling with a first counter-shaped portion 42 of the receiving seat 40 formed in the corresponding jaw 4′, 4″.

The body 60 comprises, at the second longitudinal end 62, a second shaped portion 82 which is configured to removably engage in a form-fit coupling with a second counter-shaped portion 43 of the receiving seat 40 formed in the corresponding jaw 4′, 4″.

Preferably, the first shaped portion 81 comprises, at the first longitudinal end 61, a first step 69 which is defined by two zones angled to each other, respectively a first zone 71 and a second zone 72, which meet to define a first edge 73. Conveniently, the first step 69 is defined within the thickness development of the body 60.

Preferably, the first edge 73 extends in a substantially rectilinear direction along the thickness of the body 60. More preferably, this direction is substantially parallel to the direction Z1.

Preferably, the first zone 71 comprises a substantially continuous inclined wall which is defined between the end edge 70′ and said first edge 73.

Preferably, the first zone 71 of the first step 69 comprises a substantially continuous inclined wall that is defined within the thickness of the body 60.

Preferably, the second zone 72 of the first step 69 comprises a wall, which is defined within the thickness of the body 60, into which the longitudinal central groove 68 opens.

Preferably, the first zone 71 is inclined so as to define with the bottom surface 75 a first angle (a) which is approximately 30°-60°.

Preferably, the second zone 72 is arranged so as to define with the bottom surface 75 a second angle (b) which is approximately 45°-90°. More preferably, the angle (b) is less than 90°. Advantageously, this allows the translational locking of the body 60 along a direction parallel to Y1.

Preferably, the angle between the first zone 71 and the second zone 72 is greater than 90°.

Preferably, the second zone 72 has a substantially fork-like shape, being divided into two sub-zones separated from each other by the central longitudinal groove 68. In this way, the form-fit coupling with the central longitudinal rib 44 of the receiving seat 40 allows the body 60 to be stabilized, once inserted into the receiving seat 40, preventing its rotation around a direction parallel to the axis X1.

Preferably, the first step 69 is in a lower position, along the height direction, with respect to the working portion 63; for example, the first step 69 is substantially in a lower position with respect to the first tooth 65′.

Preferably, the lower part of the body 60 comprises, along the length direction, the first step 69 which then connects with the base 64.

Preferably, the insertion edge 70 can be defined in the connection between the working portion 63 and the underlying first zone 71 of the first step 69.

Preferably, the second shaped portion 82 comprises, at the second longitudinal end 62, a terminal zone 76 which is angled with respect to the bottom surface 75.

More preferably, the terminal zone 76 comprises a wall, which is defined within the thickness of the body 60, and into which the central longitudinal groove 68 opens. More preferably, the terminal zone 76 comprises a wall which, along the height direction, extends substantially from the bottom surface 75 up to the working portion 63 and, in particular, up to a curved section 66 of the working portion 63.

Preferably, the terminal zone 76 is arranged so as to define a third angle (g) with the bottom surface 75 which is approximately 45°-90°.

Preferably, the terminal zone 76 has a substantially fork-like shape, being divided into two sub-zones separated from each other by the central longitudinal groove 68. In this way, the shape coupling with the central longitudinal rib 44 of the receiving seat 40 allows the body 60 to be stabilized, once inserted into the receiving seat 40, preventing its rotation around a direction parallel to the axis X1.

Conveniently, the engagement by form-fit coupling of the first shaped portion 81 of the body 60 with the first counter-shaped portion 42 of the receiving seat 40 and also the engagement by form-fit coupling of the second shaped portion 82 of the body 60 with the second counter-shaped portion 43 of the receiving seat 40 are configured to prevent, or in any case limit, the movement of the body 60 with respect to the receiving seat (at least) along a direction parallel to X1, and in both directions.

Preferably, the groove 68 extends from the second zone 72 to the terminal zone 76. More preferably, contact between the body 60 and the corresponding jaw 4′, 4″ occurs at the first zone 71, the second zone 72, the lateral sides 67, the longitudinal groove 68 and the terminal zone 76 of the body 60, with the longitudinal groove 68 extending from the second zone to the terminal zone.

Preferably, the body 60 is free of undercuts. In other words, the only recess present within the dimensions of the body 60—with the exception of any through holes—is defined by the longitudinal groove 68.

Preferably, the body 60 comprises at least a pair of first through holes 77 which are formed in the respective sides 67 so as to face each other, and configured to thus allow the passage of a dowel pin 90′. In particular, a first through hole 77 of the pair is formed on one side 67 while the other first through hole 77 of the pair is formed on the other side 67. Each pair of first through holes 77 is configured to be passed through by a dowel pin 90′ (or a support pin or other equivalent connecting element).

The first through holes 77 of each pair, one for each of the two sides 67, are obtained close to the bottom surface 75 and all open internally into the central longitudinal groove 68. Conveniently, a first through hole 77 obtained on one side 67 faces, along a direction parallel to Z1, another first through hole 77 (of the same pair) which is obtained on the other side 67 and both open internally into the central longitudinal groove 68.

Preferably, at least one pair of first through holes 77 is obtained so as to be closer to the second longitudinal end 62. Preferably, at least one pair of first through holes 77 is obtained asymmetrically along the length extension direction of the body 60.

In a possible and preferred embodiment, the body 60 comprises (at least) two pairs of first through holes 77, wherein:
on each of the two sides 67 (at least) two first through holes 77 are obtained which are arranged side by side along the length direction of the body 60,
the two first through holes 77 of one side 67 face two respective first through holes 77 obtained in the other side 67, and are configured to thus allow the crossing of (at least) two corresponding dowel pins 90′.

In particular, each first through hole 77 obtained in one of the sides 67 faces and aligns with a corresponding first through hole 77 obtained in the other side 67, so as to form two pairs of opposing through holes configured to allow the passage of two corresponding dowel pins 90′.

In more detail, the first through hole 77 of the first pair is obtained on one side 67 and faces, along a direction parallel to Z1, the respective first through hole 77 of the same pair which is obtained on the other side 67, and the same applies to the second pair, and all the first through holes 77 of the two pairs open internally into the longitudinal central groove 68. More preferably, the two first through holes 77 are obtained on each side 67 at the same height with respect to the bottom surface 75.

Preferably, at least one pair of through holes 77 is closer to the second longitudinal end 62 of said body 60, and wherein said second longitudinal end is opposite to said first longitudinal end 61 at which said insertion edge 70 is obtained.

Preferably, a pair of first through holes 77 is obtained substantially centrally along the length extension direction of the body 60, while the other pair of first through holes is obtained so as to be closer to the second longitudinal end 62. Preferably, the two pairs of first through holes 77 are obtained asymmetrically along the length extension direction of the body 60. Advantageously, this allows the loads on the dowel pins 90′ that pass through the pairs of first through holes 77 to be reduced during operation.

Conveniently, it is intended that—depending on the size of the clamp—more than two pairs of first through holes 77 may be provided.

Each jaw 4′, 4″, which is configured to receive a corresponding removable working member 6′, 6″, includes a receiving seat 40.

In particular, the receiving seat 40 comprises the counter-shaped base portion 41 which is configured to receive and removably engage by form-fit coupling the shaped base portion 80 of the body 60 of the corresponding removable working member.

Preferably, the receiving seat 40 extends longitudinally (and mostly) along a direction parallel to X2, and also extends along directions parallel to Y2 and Z2, where the three directions X2, Y2 and Z2 are perpendicular to each other.

Preferably, within the thickness extension of the receiving seat (i.e. along a direction parallel to Z2), the counter-shaped base portion 41 comprises a longitudinal central rib 44 which extends along a direction parallel to X2.

More preferably, said longitudinal central rib 44 is interposed between two longitudinal lateral sections 45. In particular, the longitudinal central rib 44 is raised, along a development parallel to Y2, with respect to the longitudinal lateral sections 45.

Preferably, the longitudinal central rib 44 of the receiving seat 40 is configured to fit by a form-fit coupling inside the longitudinal central groove 68 of the body 60. More preferably, the sides 67 of the body 60 abut with their respective bottom sections on the longitudinal lateral sections 45 of said receiving seat 40.

Conveniently, in a possible embodiment, the shaped base portion 80 of the body 60 may comprise the central longitudinal rib 44 while the counter-shaped base portion 41 of the receiving seat 40 may comprise the sides 67 which delimit the central longitudinal groove 68 between them.

The receiving seat 40 comprises two longitudinal end parts, respectively a first longitudinal end part and a second longitudinal end part, which are located on opposite sides along a direction parallel to X2.

Preferably, at the first longitudinal terminal part there is a support zone 52 which is intended to receive the insertion edge 70 of the body 60. More preferably, the support zone 52 comprises or is shaped like an edge.

Conveniently, the receiving seat 40 is configured so as to allow the assembly and removal of the body 60 in/from said receiving seat 40 following the rotation of the body 60 around a rotation fulcrum 55 defined by the contact of the insertion edge 70 of the body 60 with the support zone 52 of the receiving seat 40.

Preferably, the receiving seat 40 also comprises, at the first longitudinal end portion, a first counter-shaped portion 42 which is configured to receive by form-fit coupling the first shaped portion 81 of the body 60 of the corresponding removable working member. More preferably, the first counter-shaped portion 42 is configured in a complementary manner with respect to the first step 69 of the body 60.

In more detail, the first counter-shaped portion 42 may comprise a first receiving zone 48 which is intended and configured to come into contact with the first zone 71 of the body 60. Preferably, the first receiving zone 48 is inclined so as to define with a surface coplanar with the two longitudinal lateral sections 45 an angle which is substantially equal to the first angle (a) which is defined by the first zone 71 with the bottom surface 75 (see FIG. 7).

In more detail, the first counter-shaped portion 42 may comprise a second receiving zone 49 which is intended and configured to come into contact (possibly with a limited play) and/or face the second zone 72 of the body 60. Preferably, the second receiving zone 49 is inclined so as to define with a surface coplanar with the two longitudinal lateral sections 45 an angle which is substantially equal to the second angle (b) which is defined by the second zone 72 with the bottom surface 75 (see FIG. 7).

Preferably, the receiving seat 40 also comprises, at the second longitudinal terminal part, a second counter-shaped portion 43 which is configured to receive by form-fit coupling the second shaped portion 82 of the body 60 of the corresponding removable working member. More preferably, the second counter-shaped portion 43 is configured in a complementary manner with respect to the terminal zone 76 which is angled with respect to the bottom surface 75 of the body 60. In more detail, the second counter-shaped portion 43 may comprise a terminal receiving zone 50 which is intended and configured to come into contact (possibly with a limited play) and/or face the terminal zone 76 of the body 60. Preferably, the terminal receiving zone 50 is inclined so as to define with a surface coplanar with the two longitudinal lateral sections 45 an angle which is substantially equal to the third angle “g” which is defined by the terminal zone 76 with the bottom surface 75 (cf. FIG. 7).

Preferably, the receiving seat 40 comprises at least one second through hole 51 which is formed in the central longitudinal rib 44, and which is configured to thus allow the dowel pin 90′ to pass through. In particular, the second through hole 51 is formed on the central longitudinal rib 44 so that, when the latter engages by form-fit coupling in the central longitudinal groove 68 of the body 60, the second through hole 51 faces, along a direction parallel to Z1, a first through hole 77 formed on one side 67 and also another first through hole 77 (of the same pair) which is formed on the other side 67.

Preferably, a second through hole 51 is provided for each pair of first through holes 77 of the body 60.

In a possible and preferred embodiment, the receiving seat 40 comprises two second through holes 51, one for each of the two pairs of first through holes 77.

Conveniently, when the longitudinal central rib 44 engages by form-fit coupling in the longitudinal central groove 68 of the body 60, a dowel pin 90′ passes sequentially through a first through hole 77 formed in one side 67, a second through hole 51 formed in the longitudinal central rib 44, and the other first through hole 77 of the same pair which is formed in the other side 67.

Conveniently, a dowel pin 90′ is provided for each pair of through holes 77 and for each second through hole 51.

Preferably, for each dowel pin 90′, at least one ferrule 91 or other equivalent locking/retention element may be provided, more preferably an elastic ring. More preferably, said ferrule 91 may be housed inside a second through hole 51 to engage a corresponding dowel pin 90′ that passes through said second through hole. Advantageously, this allows the dowel pin 90′ to be locked in position, thus preventing it from slipping out. Advantageously, the removal and assembly of each dowel pin 90′ inside the corresponding ferrule 91 simply requires the use of a hammer and pin punch, thus reducing intervention times.

Preferably, connection elements 90 are provided—comprising dowel pins 90′ or other equivalent connecting elements—configured to pass through—once/when the shaped base portion 80 of said body is engaged by form-fit coupling with the counter-shaped base portion 41 of the receiving seat 40—the shaped base portion 80 of said body 60 and also the counter-shaped base portion 41 of the receiving seat 40, to thus block the body 60 in the receiving seat 40. In particular, advantageously, this allows the movement of the body 60 to be blocked with respect to the receiving seat 40 also along a direction Y1 or in any case in a direction opposite to that of insertion/assembly of the body 60 in the receiving seat 40. Advantageously, in this way, the body 60 is blocked in the receiving seat 40 so as to keep the bottom surface 75 of the two sides 67 in contact or in any case in close proximity to the longitudinal lateral sections 45 of the receiving seat 40.

In particular, the connection elements 90 comprise at least one connection element, such as for example a dowel pin 90′, and wherein each connection element passes through a pair of first through holes 77 obtained in the body 60 and also a second through hole 51 obtained in the receiving seat 40.

Preferably, each connection element 90—for example each dowel pin 90′—has a longitudinal extension that is greater than the extension along the direction Z1, and that is, it is greater than the thickness extension of the body 60.

Preferably, at least one connection element 90, to lock the body 60 to the receiving seat 40, is applied in a position opposite to the insertion edge 70.

Conveniently, the body 60 of the removable working member can be made of a high hardness, abrasion-resistant metal material. Preferably, the body 60 of the working member can be made of wear-resistant steel, tempered steel, or mechanically equivalent materials, for example, it can be made of HARDOX® 450.

Preferably, the 4′, 4″ jaw with the receiving seat 40 can be made of a high-hardness, abrasion-resistant metal material. Preferably, the 4′, 4″ jaw with the receiving seat 40 can be made of wear-resistant steel, tempered steel, or mechanically equivalent materials, for example, it can be made of HARDOX® 450.

The operation of a preferred embodiment of the solution according to the invention clearly follows from what was previously stated.

In particular, for the assembly of a removable working member 6′, 6″ in the receiving seat 40 of a corresponding jaw 4′, 4″, the end edge 70′ of the body 60 is brought, thus defining the insertion edge 70, into contact with the support zone 52 of the receiving seat 40 to thus define a rotation fulcrum 55 around which the body 60 is rotated, in a first direction of rotation, until the shaped base portion 80 of said body is brought to engage by form-fit coupling with the counter-shaped base portion 41 of the receiving seat 40. Preferably, by means of this rotation of the body 60 in said first direction of rotation, also the first shaped portion 81 of said body is engaged by form-fit coupling with the first counter-shaped portion 42 of the receiving seat 40 and also the second shaped portion 82 of said body is engaged by form-fit coupling with the second counter-shaped portion 43 of the receiving seat 40. Preferably, the connection elements 90 are then applied to lock or in any case further lock, in all three directions, the body 60 to the receiving seat 40; in particular, a dowel pin 90′ can then be applied to each pair of first through holes 77 so that said dowel pin 90′ passes through said first through holes 77 and also the interposed second through hole 51. More preferably, the portion of dowel pin 90′ that passes through the second through hole 51 may be engaged by a ferrule 91 housed in said second through hole.

Conveniently, to remove the removable working member from the receiving seat 40 of a corresponding jaw 4′, 4″ the above operations are carried out in reverse sequence. In particular, first the connection elements 90 are removed and, in particular, after the possible removal of the respective ferrules 91, all the dowel pins 90 are extracted from the respective first through holes 77 and second through holes 51. The body 60 is rotated, in a second direction which is opposite to the aforementioned first direction, around the rotation fulcrum 55 defined by the contact between the insertion edge 70 of said body and the support zone 52 of the receiving seat 40, to thus disengage the shaped base portion 80 of said body from the counter-shaped base portion 41 of the receiving seat 40. Preferably, by means of this rotation of the body 60 in said second direction of rotation, also the first shaped portion 81 of said body disengages from the first counter-shaped portion 42 of the receiving seat 40 and also the second shaped portion 82 of said body disengages from the second counter-shaped portion 43 of the receiving seat 40. Conveniently, following this rotation of the body 60 in said second direction of rotation, it is then possible to remove (space apart) the body 60 from the receiving seat 40.

The present invention also relates to the removable working member only, as described above, for a demolition clamp 1.

In a possible variant (cf. FIGS. 10-12), the body 60 can be made of two or more pieces, including a first end piece 60′ and a second end piece 60″. Advantageously, this variant allows only the piece with worn parts to be replaced, reducing maintenance costs.

Preferably, each of the two pieces 60′ and 60″ is provided with a respective end edge 70′ and 70″, each of which defines a corresponding insertion edge 70, to allow a rotary engagement, with the fulcrum at said respective engagement edge of the corresponding piece 60′ or 60″ of said body 60, in the receiving seat 40. Preferably, each end edge 70′ and 70″ is a sharp edge.

Conveniently, therefore, the assembly and removal of each piece 60′ and 60″ in/from the corresponding zone of the receiving seat 40 occurs by rotating the corresponding piece.

Preferably, the two pieces 60′ and 60″—as a whole—define a body 60 with the characteristics described above with reference to the embodiment illustrated in FIGS. 1 to 9D.

Preferably, the two pieces 60′ and 60″ internally comprise respective contact zones, 74′ and 74″ respectively, which are shaped so as to come into mutual contact when the two pieces 60′ and 60″ are mounted in the receiving seat 40 and also so as to allow the relative rotation of one piece with respect to the other when both are mounted in the receiving seat 40, for example allowing the second piece 60″ to be able to rotate with respect to the first piece 60′ when the latter is mounted in the receiving seat. Preferably, the respective contact zones 74′ and 74″ of the two pieces 60′ and 60″ have a complementary profile and, more preferably, said profile is substantially rounded with an appropriate radius of curvature R.

Preferably, the first shaped portion 81 is defined at a longitudinal end (which is opposite to the respective contact zone 74′) of the first piece 60′ while the second shaped portion 82 is defined at a longitudinal end (which is opposite to the respective contact zone 74″) of the second piece 60″.

More preferably, the first shaped portion 81 has a symmetrical shape corresponding to that of the second shaped portion 82 and, in particular, each of said two shaped portions comprises a respective step which is defined by two zones angled to each other, respectively a first zone and a second zone, which meet to define a corresponding edge. In a possible and preferred embodiment, both for the first 81 and for the second shaped portion 82, the corresponding first zone is inclined so as to define a first angle (a) of approximately 30°-60° with the corresponding bottom surface, while the corresponding second zone is arranged so as to define a second angle (b) of approximately 45°-90° with the corresponding bottom surface. More preferably, the first angle (a) of said first shaped portion 81 is equal to that of said second shaped portion 82 and/or the second angle (b) of said first shaped portion 81 is equal to that of said second shaped portion 82.

Advantageously, the presence of the radius of curvature R in the respective contact zones 74′ and 74″ allows for the definition of a rounded contact surface between the first piece 60′ and the second piece 60″, such as to permit a controlled relative rotation between the two pieces when they are mounted in the receiving seat 40. In particular, this rounded conformation facilitates the relative movement between the two pieces during assembly and disassembly operations.

Preferably, the configuration of the contact zones 74′ and 74″ with said radius of curvature R allows for the sequential removal of the two pieces. In particular, the second piece 60″ can be removed from the receiving seat 40 by rotating it around its own insertion edge 70″; subsequently, once the second piece 60″ has been removed, it is possible to proceed with the removal of the first piece 60′ by rotating it around its own insertion edge 70′, in a direction of rotation opposite to that used for the removal of the second piece 60″.

Advantageously, when both pieces 60′ and 60″ are mounted in the receiving seat 40, the second piece 60″ also performs a locking function with respect to the rotation of the first piece 60′. In this way, the first piece 60′ is stably retained in the receiving seat 40 until the second piece 60″ is previously removed, thus improving the overall stability of the body 60 and preventing accidental removal of the individual pieces.

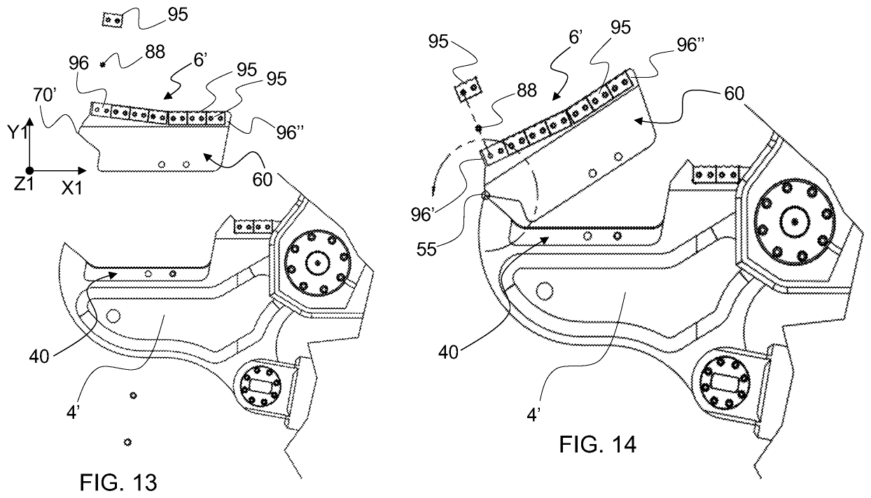

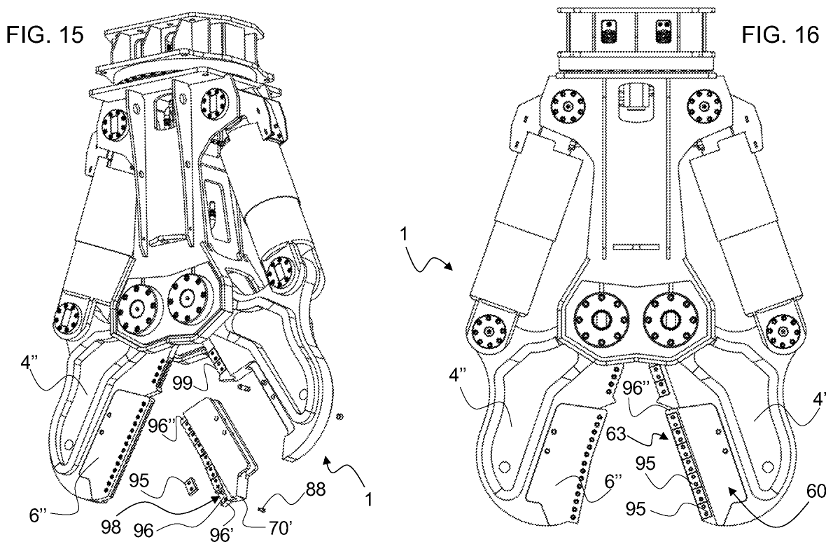

Preferably, in a possible embodiment (cf. FIGS. 13-16), the working portion 63 of the removable working member 6′ may comprise a plurality of cutting inserts 95. Conveniently, the cutting inserts 95 are configured to act as knives.

Preferably, the cutting inserts 95 are made of high-strength metal material, such as high-strength steel.

Advantageously, this configuration allows the use of the removable working part 6′ to be extended to the cutting of bundles of metal reinforcement present inside the reinforced concrete, an operation that would not be possible with only the cutting elements 99 already provided in the jaw near the fulcrum.

Preferably, the cutting inserts 95 of the working portion 63 are removable. More preferably, the cutting inserts 95 are fixed next to each other along the length of the body 60, for example by means of bolts 88, screws or other equivalent fastening elements. Preferably, such cutting inserts 95 are fixed to an abutment wall 96.

Preferably, the working portion 63 comprises a housing 98 for the cutting inserts 95. In particular, this housing 98 can be delimited by two end walls 96′ and 96″ connected to each other by the abutment wall 96. In a possible embodiment, the end walls 96′ and 96″ are arranged substantially parallel to the plane Y1-Z1 and orthogonally with respect to the abutment wall 96, which extends longitudinally along a direction substantially parallel to X1.

Preferably, the cutting inserts 95 comprise a cutting profile with a knurled or wavy pattern.

Advantageously, the cutting profile in combination with the housing 98 allows for the movement of the cutting inserts 95 to be limited during cutting operations, increasing their operating efficiency.

Advantageously, this variant allows the same demolition clamp to be used also for cutting metal reinforcement bars in reinforced concrete by only replacing the interchangeable cutting inserts, thus reducing usage and maintenance costs.

The present invention also relates to a demolition clamp 1 comprising:
a frame 2 which is provided with a connection attachment 3 configured to connect the demolition clamp 1 to an earthmoving machine,
two jaws 4′, 4″, of which at least one is movable and is articulated to the frame 2,
at least one linear actuator 5′, 5″ for each movable jaw, and wherein said at least one linear actuator has one end articulated to the frame 2 while the opposite end is articulated to the corresponding movable jaw 4′, 4″,
two working members 6′, 6″, one for each jaw 4′, 4″,
and wherein:
at least one of said working members 6′, 6″ comprises a removable working member according to one or more of the preceding claims,
in at least one jaw 4′, 4″ a receiving seat 40 is obtained which is configured to receive said removable working member, said receiving seat 40 comprises a counter-shaped base portion 41,
said shaped base portion 80 is configured to removably engage by form-fit coupling with the counter-shaped base portion 41 of said receiving seat 40,
said clamp comprises connection elements 90 configured to pass through the shaped base portion 80 of said body 60 and also the counter-shaped base portion 41 of the receiving seat 40, thereby locking the body 60 in the receiving seat 40.

The present invention also relates to an earthmoving machine, preferably an excavator, comprising a demolition clamp as described above. In a preferred embodiment, the demolition clamp 1 is connected (preferably by means of a quick-release system) to one end of an articulated arm of the earthmoving machine.

As is clearly evident from what has been said, the solution according to the invention is particularly advantageous, as it allows the drawbacks of the known solutions to be overcome and, in particular:
allows the replacement of working members even on large demolition clamps (with a mass greater than 4000 kg), thus ensuring greater operational versatility,
allows to reduce the replacement times of the removable working member, optimizing maintenance operations and increasing overall efficiency,
allows high reliability, ensuring safe fixing and a long operating life of the working member,
improves operating performance, allowing the design of a working member with a reduced height, which maximizes the concentration of forces during demolition, thus allowing better performance in terms of reduction of working times, fuel consumption and machine downtime,
increases safety during maintenance operations, limiting risks for operators and simplifying intervention procedures.

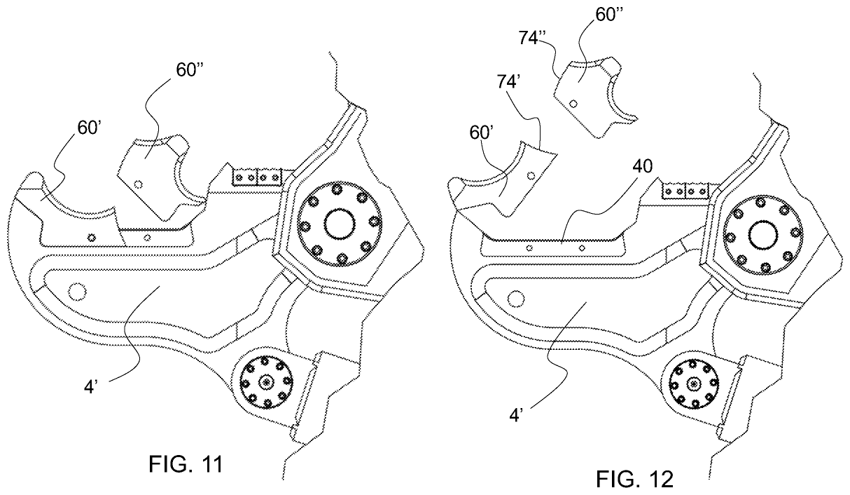

Furthermore, the variant illustrated in FIGS. 11 and 12 allows for reduced maintenance costs, as it is possible to selectively replace only a part of the body 60, without having to replace the entire member, thus allowing for faster and more cost-effective interventions. In this variant, the configuration of the contact zones with the curvature radius R also allows for quick and safe removal of the pieces 60′ and 60″, facilitating disassembly and assembly operations and reducing intervention times during maintenance activities.

Furthermore, in the variant illustrated in FIGS. 13-16, the body 60 also allows the cutting of large bundles of metal reinforcement bars for reinforced concrete, thus expanding the possible operational applications of the corresponding demolition clamp and the machine on which it is installed, increasing its versatility of use in the demolition and materials recycling sector.

The present invention has been illustrated and described in some of its preferred embodiments, but it is intended that executive variations may be made to them in practice, without however departing from the scope of protection of the present patent for industrial invention.

The invention, thus conceived, is susceptible to numerous modifications and variations, all of which fall within the scope of the inventive concept; furthermore, all the details may be replaced by other technically equivalent elements.

In practice, the materials used, as well as the dimensions, can be any according to the needs and the state of the art.

What is claimed is:

1. Removable working member for a demolition clamp, comprising a body, wherein said body comprises:
a working portion which is configured to come into contact with the material to be demolished,
a base with a shaped base portion that is configured to removably engage by form-fit coupling with a counter-shaped base portion of a receiving seat formed in a corresponding jaw,
an end edge which defines a longitudinal end of the body and which extends in a substantially continuous manner for the entire thickness of the body.

2. The removable working member according to claim 1, wherein the end edge extends in a substantially continuous manner along a substantially rectilinear direction for the entire thickness of the body, thus defining an insertion edge to allow a rotary insertion, with fulcrum at said insertion edge, of the body into the receiving seat.

3. The removable working member according to claim 1, wherein the end edge is a sharp edge.

4. The removable working member according to claim 1, wherein the body comprises at least one of:
at a first longitudinal end, a first shaped portion which is configured to removably engage by form-fit coupling with a first counter-shaped portion of the receiving seat, or
at a second longitudinal end, which is opposite said first longitudinal end, a second shaped portion which is configured to removably engage by form-fit coupling with a second counter-shaped portion of the receiving seat.

5. The removable working member according to claim 1, wherein the shaped base portion of the body comprises a longitudinal central groove which is interposed between two lateral sides and which is configured to receive a longitudinal central rib obtained in the receiving seat.

6. The removable working member according to claim 1, wherein:
said body is made of at least two pieces,
each of said at least two pieces comprises, at a first longitudinal end and at a second longitudinal end of said body, a respective end edge, each of which defines a corresponding insertion edge to allow a rotary insertion, with fulcrum at said insertion edge, of a corresponding piece of said body, in the receiving seat.

7. The removable working member according to claim 1, wherein the body comprises, at a first longitudinal end, a first shaped portion comprising a first step which is defined by two zones angled towards each other, respectively a first zone and a second zone, which meet to define a first edge, and wherein the first zone comprises a substantially continuous inclined wall which is defined between the end edge and said first edge.

8. The removable working member according to claim 7, wherein:
the first zone is inclined so as to define with the bottom surface a first angle of approximately 30°-60°,
the second zone is arranged so as to define a second angle of approximately 45°-90° with the bottom surface.

9. The removable working member according to claim 1, wherein:
the body comprises two lateral sides,
the base of the body comprises a bottom surface defined by the bottom sections of the lateral sides,
the body comprises, at the second longitudinal end, a second shaped portion comprising a terminal zone which is angled with respect to the bottom surface.

10. The removable working member according to claim 9, wherein the terminal zone is arranged so as to define a third angle of approximately 45°-90° with the bottom surface.

11. The removable working member according to claim 1, wherein:
the body comprises, at the first longitudinal end, a first shaped portion comprising a first step which is defined by two zones angled towards each other, respectively a first zone and a second zone, which meet to define a first edge, and wherein the first zone comprises a substantially continuous inclined wall which is defined between the end edge and said first edge,
the body comprises two lateral sides,
the base of the body comprises a bottom surface defined by the bottom sections of the lateral sides,
the body comprises, at the second longitudinal end, a second shaped portion comprising a terminal zone which is angled with respect to the bottom surface,
the shaped base portion of the body comprises a longitudinal central groove extending from the second zone to the terminal zone.

12. The removable working member according to claim 1, comprising at least a pair of first through holes which are obtained on respective lateral sides of the body so as to be aligned with each other, thus allowing the through passage of a corresponding connection element, which also passes through a second through hole obtained in the counter-shaped portion of the receiving seat.

13. The removable working member according to claim 12, wherein at least one pair of first through holes is closer to a second longitudinal end of said body, and wherein said second longitudinal end is opposite to a first longitudinal end at which an insertion edge is obtained to allow a rotary insertion, with fulcrum at said insertion edge, of the body in the receiving seat.

14. The removable working member according to claim 11, wherein the body comprises two lateral sides and two pairs of first through holes, and wherein:
on each of the two lateral sides two first through holes are made which are arranged side by side along the length direction of the body,
each first through hole obtained in one of the lateral sides faces and aligns with a corresponding first through hole obtained in the other lateral side, so as to form two pairs of counterposed through holes configured to allow the passage of two corresponding connection elements.

15. The removable working member according to claim 1, wherein the body is made of two pieces and wherein the two pieces internally comprise respective contact zones which are shaped in such a way as to come into mutual contact when the two pieces are mounted in the receiving seat and also in such a way as to allow the relative rotation of one piece with respect to the other when both are mounted in the receiving seat.

16. The removable working member according to claim 15, wherein the respective contact zones of the two pieces have a complementary profile.

17. The member according to claim 15, wherein a first shaped portion, which is configured to removably engage by form-fit coupling with a first counter-shaped portion of the receiving seat, is defined at a longitudinal end of the first piece while a second shaped portion, which is configured to removably engage by form-fit coupling with a second counter-shaped portion of the receiving seat, is defined at a longitudinal end of the second piece.

18. The removable working member according to claim 17, wherein the first shaped portion has a conformation which is symmetrical and corresponding to that of the second shaped portion.

19. The removable working member according to claim 1, wherein the working portion comprises a plurality of cutting inserts which are removable.

20. Demolition clamp comprising:
a frame which is provided with a connection attachment configured to connect the demolition clamp to an earthmoving machine,
two jaws, at least one of which is movable and is articulated to the frame,
at least one linear actuator for each movable jaw, and wherein said at least one linear actuator has one end articulated to the frame while an opposite end thereof is articulated to the corresponding movable jaw,
two working members, one for each jaw,
and wherein:
at least one of said working members comprises a removable working member according to claim 1,
in at least one jaw, a receiving seat is obtained which is configured to receive said removable working member, said receiving seat comprises a counter-shaped base portion,
said shaped base portion is configured to removably engage by form-fit coupling with the counter-shaped base portion of said receiving seat,
said clamp further comprises connection elements configured to pass through the shaped base portion of said body and the counter-shaped base portion of the receiving seat, thus locking the body in the receiving seat.
